(19) United States
(12) Patent Application Publication
(10) Pub. No.: US 2024/0185596 A1
(43) Pub. Date: Jun. 6, 2024

(54) DEVICE AND METHOD FOR CHECKING A MARKING OF A PRODUCT

(71) Applicant: REA Elektronik GmbH, Mühltal (DE)

(72) Inventors: Michael NEUSCHÄFER, Mühltal (DE); Stephan STRELEN, Kreuzlingen (CH)

(73) Assignee: REA Elektronik GmbH, Mühltal (DE)

(21) Appl. No.: 18/285,907

(22) PCT Filed: Apr. 8, 2022
(86) PCT No.: PCT/EP2022/059400

§ 371 Date: Oct. 6, 2023

(30) Foreign Application Priority Data
Apr. 9, 2021 (DE) 10 2021 108 925.5

(51) Int. Cl. G06V 10/98; G06V 10/141; G06V 10/143

(52) U.S. Cl. CPC G06V 10/993; G06V 10/141; G06V 10/143

(57) ABSTRACT

A method for checking a marking of a product. In an image acquisition step (3) at least one image (4) of the marking arranged on a surface of the product is acquired by a calibrated test camera, and in a layout checking step (1), using the at least one recorded image (4), the quality of the marking applied on the surface is checked with respect to static data such as position and machine-readability. Using the at least one image (4) recorded by the test camera, in addition to the checking of the quality of the marking in the layout checking step (1), in a code checking step (2), variable product information (12) contained in the marking is acquired and the acquired variable product information is compared with reference information from a reference information database (13). A correspondence characteristic is determined by means of the comparison.

### CROSS-REFERENCE TO RELATED APPLICATION

This application is a national stage application, filed under 35 U.S.C. § 371, of International Patent Application PCT/EP2022/059400, filed on Apr. 8, 2022, which claims the benefit of German Patent Application DE 10 2021 108 925.5, filed on Apr. 9, 2021.

### TECHNICAL FIELD

The disclosure relates to a method for checking a marking of a product.

### BACKGROUND

In order to identify products, markings for example in the form of inscribed labels, imprints, or also engravings are used. They serve firstly for unique identification of a finished product, and can furthermore allow for identification and tracking of products even after individual production steps. Markings in the form of labels comprise an upper side that is provided with information, and an underside, wherein the labels are applied, by the underside, to the product to be marked. Furthermore, it is possible to print the marking directly onto the product to be marked or its packaging by means of one or more working heads, to spray it on, or to burn it in by means of a laser.

However, in addition to the identification of a finished product by the user, markings are also used in a closed internal system. For example, they are common in production, wherein after each production step the product has to be easily assignable and traceable, in order to be able to act quickly in the event of faults or complaints. Furthermore, incorrectly or erroneously applied markings must be found and corrected promptly, since renewed marking of the goods could lead to a stop of production, destruction of the incorrectly marked goods, for example in the case of perishable products such as good, or a costly re-marking. In order to be able to ensure, after the application of the marking, that a subsequent check can be reliably carried out, it is necessary to firstly check the quality of the marking applied to the product. In this case, a check is performed as to whether the marking is applied to the product at the intended location and in the intended orientation, and whether the marking has been produced or applied such that it is sufficiently clearly legible.

For this reason, methods for checking the layout of a marking are used, and the marking is checked in a layout checking step. The checking is usually carried out by means of an optical method, i.e. by recording at least one image of the marking using a calibrated test camera, wherein in the marking is checked with regard to static data such as the position, as well as its machine-readability. The check for machine-readability includes inter alia the checking for the contrast, i.e. how well the marking stands out from the surface bearing the marking. The check of the quality includes inter alia all elements of the marking being present and being implemented without errors. In this case, the actual layout to be checked is compared with reference data of a target layout from a reference database. Said mentioned static quality criteria of the marking are crucial for an optimum first reading rate and registration processes by means of cameras, scanners, but also checkout systems.

In addition to static information, a marking generally comprises variable data such as production information or information relating to the type or the content of the relevant product, wherein this information can be referred to, in summary, as product information. The at least one item of product information can be arranged in at least one product information region in the marking, or also separately on the product. The product information is typically required at different timepoints during the transport, storage and sale of the products in question, and is read out, interpreted, and optionally matched with reference data, at the relevant time, in a code checking step. For said code checking step a further second device can be used, which is capable of identifying and interpreting machine-readable code, for example using a barcode reader or using a QR code scanner.

Said machine-readable product information can be applied in an encrypted manner in part, and is typically created from a binary system. This includes optoelectronically readable product information such as one-dimensional bars or barcodes. They consist of lines of different thicknesses which are arranged so as to be spaced apart and in parallel with one another, and which can be read out and interpreted by machine. A prominent example for the use of one-dimensional codes is open systems, such as price labelling of an item in a shop. Furthermore, two-dimensional codes such as QR codes are known, which consist of a square matrix of black and white dots which encrypt information in a binary system. Two-dimensional codes can be for example communications of information, such as links or Internet pages, to customers, in the form of a QR code. Various ISO/IEC standards having different quality parameters, such as ISO/IEC 15416, ISO/IEC 15415, ISO/IEC 15416-1, ISO/IEC 15416-2, ISO/IEC 15420, ISO/IEC 15417, ISO/IEC 16022, and ISO/IEC 30116, are available for this coding.

However, in addition to this encrypted product information already discussed, unencrypted product information in the form of writing, characters or languages can also be checked. The identification of the language of a marking of a product is becoming more important due to the ever greater networking within Europe but also due to the growing global export, and not every employee is capable of immediately and unequivocally identifying every language of the marking of goods. Furthermore, however, in the code checking step security elements applied to the goods, such as holograms or the like, can also be identified and checked.

All methods to date for checking a marking share the feature of the marking being checked, in a first layout checking step, by means of a first device, for static data such as the quality and the machine-readability, and, at a later time, in a code checking step, the product information contained in the marking being read out and checked either by an observer, with the naked eye, or by means of a further second device. In this case, the code checking steps carried out in each case are usually carried out in a standard-compliant manner. In this case, checks of this kind are not subject to any requirements with respect to measurement technology, and provide different and ultimately non-reproducible results. In this case, layout and/or code errors which are not identified can result in rejects and complaints.

Furthermore, the problem is known from practice that, during the product marking, although the marking is applied to the product in a high-quality manner and the layout check is successfully completed in the layout checking step, an incorrect marking is nonetheless applied, which marking either does not relate to the product in question, or contains the product information in an incorrect language or coding. This can often be identified only at a relatively late point in time, as a result of which it may be the case that a large number of products have then been provided with incorrect markings, and the outlay for retrospective correction is significant.

### SUMMARY

The disclosure relates to a method for checking a marking of a product, wherein, in an image acquisition step, at least one image of the marking arranged on a surface of the product is acquired by means of a calibrated test camera, and wherein, in a layout checking step, using the at least one recorded image the quality of the marking applied to the surface is checked with respect to static data such as position and machine-readability.

An object of the disclosure is that of providing a method by means of which a high-quality and correct marking of products can be identified as easily and quickly as possible.

This is achieved in that, using the at least one image recorded using the test camera, in addition to the checking of the quality of the marking in the layout checking step, in a code checking step variable product information contained in the marking is acquired, and the acquired variable product information is compared with reference information from a reference information database, wherein by means of the comparison a correspondence characteristic is determined and the marking is successfully checked if the correspondence characteristic exceeds a predefinable success threshold.

At least one image of the marking that is to be checked and is arranged on a product can be recorded by means of the calibrated test camera, which is for example an APS (active-pixel sensor) or a CCD camera. In this case, the test camera is arranged in such a way that it is directed onto the marking at a specific predetermined distance and angle. In order to check the static data of the marking, in the layout checking step an actual layout is generated from the at least one image recorded by the test camera. For example, the actual layout can be generated in that the edges of the image are extracted, by means of a suitable digital filter, and stored in a suitable data structure, as an edge model. This generated edge model can subsequently be checked, using the target layout in the reference information database, with respect to static data such as position and machine-readability.

During the comparison of the actual and the target layout, the correspondence characteristic is determined, wherein in the event of a predetermined threshold value of the correspondence characteristic being exceeded, i.e. in the event of a predefined correspondence of the edge model with the specification, test regions defined in advance on the marking, which regions contain variable product information data, are cut out, and can be directly supplied to the code checking. Depending on the type of variable data anticipated in the product information regions, such as graphics, writing or code, in each case evaluation algorithms adapted thereto can be applied, in order to be able to match the detected variable data with reference information from the reference information database.

Therefore, two different checks or different recordings of the marking are not required, in order to check both the completely different aspects of the static data representing the quality of the marking, and the correctness of the product information contained in the marking. The correspondence characteristic determined by means of the method is also dependent on the product information, such that a marking located on the product only successfully completes the check if the product information contained in the marking is also correct or successfully completes the check.

In an advantageous embodiment it is provided that, in the code checking step, the language of the marking is identified by means of a comparison of the acquired variable product information with language information from the reference information database. By means of such matching of the language information arranged in the at least one product information region, a possibly incorrect marking with respect to the language of the marking that is used can be identified. The check can be carried out soon after the marking, or can also be used for checking stocks. The language information of the reference information database can be composed of predefined isolated keywords, which are provided to the reference information database via an interface or by means of an input device, for example a keyboard. Furthermore, identification of the language by means of matching the acquired language with dictionary entries, using an AI-based or OCR algorithm, or using an artificial neural network, is possible.

In an advantageous implementation it is provided that, in the code checking step, the product information, encrypted in at least one one-dimensional or multi-dimensional and machine-readable code and/or security element, is acquired and is compared by means of a comparison of the acquired variable product information with reference product information from the reference information database. The variable product information of the marking that is to be checked in the code checking step can be encrypted in one-dimensional codes such as a barcode, or also by means of two-dimensional codes such as QR codes. Furthermore, the variable product information can be encrypted in a security element. A security element is understood to mean all features of a marking which serve to prevent or at least hinder forgery and/or unauthorised duplication of the marking. In the case of the use of graphics as security elements, these can also be transferred, by means of an edge extraction algorithm, into an edge model, and matched with reference product information. Holograms or also optically variable features can be used. A hologram is understood to be a feature of the security element which can generate an image by means of holography. Optically variable features are understood to be for example kinegrams, wherein the security feature of the kinegram can display different images at different viewing angles. The check can be made possible by two or more recorded images which show the security feature from different perspectives relative to the surface of the marking, wherein subsequently, as in the case of the checking of graphics, an edge extraction algorithm is used.

Advantageously it is optionally provided that, in the image acquisition step, the test camera is designed in such a way that electromagnetic radiation, in particular ultraviolet light and/or visible light and/or infrared light, which is directed by a light source onto the marking and is reflected thereby, is acquired by the test camera and processed in a data processing facility. The calibrated test camera is designed such that a portion of the light spectrum which can extend from ultraviolet light as far as infrared light can be acquired and stored and further processed in the data processing facility. The light source can for example be designed as a line light source, which is preferably of a length that is greater than the largest extension of the marking to be illuminated. In this case, the light source is preferably designed as an LED lamp. Moreover, a further second light source can be arranged such that it illuminates the marking at an angle deviating from the first light source. Thus, shadowing and occurring reflections can be reduced, in particular in the case of shiny or varnished surface of the marking, and thus simultaneously the machine-readability can be increased. The second light source can have the same emitted light spectrum or a different one, compared with the first light source. A further test camera can optionally also be used, which is directed onto the marking at an angle that differs from the angle of the first test camera. Furthermore, the further second test camera can be suitable for being able to detect a light spectrum that is different from that of the first test camera. Moreover, the marking itself or individual partial regions or elements can be designed such that they do not reflect in the visible range of the light spectrum, but rather at greater or smaller wavelengths. Furthermore, a variant is conceivable in which the marking or parts of the marking emit a light spectrum that can be acquired by the test camera only after irradiation.

It is also possible, and optionally provided that, in the image acquisition step, the at least one image recorded by the test camera can be stored in a storage device of the data processing facility. The storage device is designed such that the image information of the at least one recorded image can be stored in a suitable data format, read out and, if required, transmitted via a suitable interface. In this case, electronic storage means, in particular solid state memories such as SSD memories or flash memories, magnetic storage devices such as HDD memories, optical storage means such as DVDs, or also magneto-optical memories.

It is preferably provided that, in a reference database generation step, a target layout comprising the desired static data of the marking is generated, wherein the target layout is stored in the reference information database, wherein the static data of the target layout are compared with the static data of an actual layout, and wherein a correspondence characteristic is determined by means of the comparison. The target layout can be provided to the reference information database directly, as a digital file, via an interface, or it is possible to generate the target layout by means of an optical method. In the case of generating the target layout by means of an optical method, firstly at least one image of the marking can be recorded, in a manner analogous to the recording of an image in the image acquisition step of the actual layout. The edges of the at least one recorded image can be extracted using a suitable digital filter and stored in the storage device as an edge model. The at least one product information region to be checked, which contains at least one item of variable product information, can now be characterised in the edge model, wherein the positions of the at least one product information region is stored in a manner dependent on the edge model. It is thus possible to achieve precise definition of the position of the at least one product information region, even if the marking is rotated or shifted during the comparison of the edge models with one another. Furthermore, for each of the at least one defined product information regions, the type of product information to be checked or the plurality of items of product information contained there can be stored. These include an edge model, a text field, a date field, and/or a one-dimensional or multi-dimensional code. The edge model of the marking, the defined at least one product information region, and the relative position thereof in the marking can subsequently be stored, and uniquely assigned by means of a code.

The target layouts which are stored in the reference information database and can be uniquely assigned via a code can be compared with the static data of the actual layout. In the layout checking step, the edge model of the at least one image generated in the image recording step is compared with the edge model of the target layout for possible correspondence. In this case, the edge model of the actual layout is rotated, scaled and shifted, for the best possible correspondence, by means of a suitable algorithm, until the correspondence is maximised. The correspondence characteristic determined in this case shows the degree of correspondence of the two edge models. In the event of a predetermined value of the correspondence characteristic being exceeded, the layout checking step is considered to have been completed, and the actual layout is transferred to code checking.

The described method for determining the correspondence characteristic can be carried out using the complete marking, but also using parts of the marking. It is thus also possible to carry out the code checking step using only an extract of the marking. This step increases the certainty of the determination in the case of comparison of very similar markings in which the distinguishing features are only indistinct or occur only in defined test regions.

It is furthermore possible, and optionally provided, that, in the image recording step, the actual layout is generated from the static data from the at least one recorded image, wherein the actual layout is stored in the storage device, and wherein the static data of the actual layout are compared with the static data of the target layout, wherein a correspondence characteristic is determined by means of the comparison. The actual layout can be generated from the recorded image of the marking to be checked, wherein the recorded image is transferred, by means of a suitable digital filter, into an edge model. The edge model of the actual layout can be stored in the storage device and compared, in the layout check, with the edge model of the target layout, for possible correspondence.

According to an advantageous implementation, it is provided that the target layout is a generated edge model of the desired marking, wherein the target layout is stored in the reference information database as an edge model. By means of a suitable digital filter, the edges of the image can be extracted, and the recorded image of the marking can be transferred into an edge model. Said edge model can be stored in the reference information database, in the database generation step. During checking, the actual layout is shifted and/or rotated until the correspondence of the two layouts is maximised. In addition to the transfer of the recorded images into edge models, the images to be compared can also be compared with one another by means of other algorithms. This includes, for example, the images being divided, by pixels, into brightness steps, and the brightness steps are checked, using reference data, until there is maximum correspondence, or the recorded images as a whole are compared with one another.

Advantageously, it is optionally provided that the actual layout is an edge model, wherein the edge model is generated from the at least one image recorded in the image recording step, and wherein the actual layout is stored in the storage device as an edge model for comparison with the target layout. The transfer of an image of the marking to be checked into an edge model offers the advantage that even complex markings can be reduced to necessary features and also stored quickly and in a space-saving manner in a storage device, compared with one another, and further processed. In this case, a greater throughput of edge model comparisons per unit of time can be achieved.

According to an advantageous embodiment, it is provided that the correspondence characteristic determined in the layout checking step, in the event of a value of the correspondence being exceeded the at least one product information region is cut out of the actual layout, wherein in the code checking, the variable product information of the cut-out product information regions is checked. In the case of a successful layout checking step, i.e. in the case of a predetermined value of the correspondence characteristic being exceeded, the at least one product information region defined in the target layout is cut out in the actual layout and supplied to the code checking step. In the code checking step, the type of product information to be expected can be identified, and the information contained therein can be read out and compared with the reference information of the product information database.

The disclosure also relates to a device for checking a marking of a product, wherein, in an image acquisition step, at least one image of the marking arranged on a surface of the product is acquired by means of a calibrated test camera, and wherein, in a layout checking step, using the at least one recorded image the quality of the marking applied to the surface is checked with respect to static data such as position and machine-readability.

In the prior art, a first device is used for checking a marking of a product with respect to static data such as position and machine-readability, wherein the static data are compared, in a layout checking step, with reference data of a reference database. In contrast, for checking variable product information arranged in encrypted or non-encrypted form in the marking, a further second device is used, which, in a code checking step, can read out the product information and compare it with reference information of a reference information database.

The object of the present disclosure is therefore considered to be that of providing a device which makes it possible for the layout checking step and the code checking step to be carried out using the device.

The object is achieved in that the device comprises a digital data processing facility which is designed such that, using the at least one image recorded using the test camera, in addition to the checking of the quality of the marking in the layout checking step, in a code checking step variable product information contained in the marking is acquired, and the acquired variable product information is compared with reference information from a reference information database, wherein by means of the comparison a correspondence characteristic is determined.

The test camera used is implemented in particular as a CMOS or CCD camera, wherein the test camera is preferably arranged and fixed at a fixed angle and distance with respect to the marking to be checked, or can be moved towards the marking of the product from the outside. The test camera is suitable for producing and forwarding high-resolution images of the markings to be checked. For this purpose, the test camera can be connected for signal transmission to a digital data processing facility, which makes it possible for recorded images to be stored, compared with one another, and further processed, in the digital data processing facility. In addition to the use of a test camera, it is possible for further test cameras to be used in addition to the first test camera, which further test cameras are directed onto the marking at an angle that deviates from the first camera. In this case, images of the marking can be acquired from different viewing angles, as may be necessary for example when checking security elements.

After the code checking step has been performed and the correspondence characteristic determined, it is possible to decide, on the basis of the correspondence characteristic, whether the marking also contains the relevant product information, or whether a correction or at least a more extensive check of the product information in the marking of the product is necessary. In this case, in general the correspondence characteristic is compared with a predeterminable success threshold value, and a marking that is correct in content and is of sufficiently high quality is assumed when the correspondence characteristic is above the success threshold.

It is also possible, and optionally provided, that the data processing facility may comprise a storage device that is connected to the test camera, wherein, in the image recording step, images recorded by the test camera can be stored in the storage device. The storage device can be implemented as an electronic memory, in particular a solid state memory such as an SSD memory or flash memory, a magnetic storage device such as an HDD memory, optical storage means such as DVDs, or also magneto-optic memories The storage device is connected to the test camera for signal transmission, such that images recorded using the test camera can be stored in the storage device and called up again.

It is furthermore possible, and optionally provided that the data processing facility may comprise a database, wherein the database is connected for signal transmission to the storage device, such that images stored in the storage device can be matched with images of the database. The database can preferably comprise a database management system and a data corpus. The data corpus comprises the quantity of the stored data, in particular images and edge models of the actual and target layout, in suitable file formats, wherein the database management system can determine and control the access and storage of the data.

According to an advantageous implementation, it is provided that the test camera comprises at least one light source, by means of which the marking to be checked can be illuminated. The light source is preferably a beam light source, in particular an LED lamp, which is directed to the marking to be illuminated and checked, and can fully illuminate said marking. The light source can be arranged and fixed on the test camera for example as a ring light, wherein a variant is also conceivable in which the light source is arranged so as to be spaced apart from the test camera and, if required, can be shifted. Furthermore, it is conceivable that at least one further light source is arranged, which preferably illuminates the marking in an angle deviating from the first light source, in order to prevent or to minimise shadowing and/or reflections of the marking. The light source can also be arranged so as to be spaced apart from the marking to be checked, wherein the light can be directed onto the marking by means of a light guide. The light source can preferably output a predetermined spectrum of ultraviolet light and/or visible light and/or infrared light, wherein light sources having a different electromagnetic spectrum can be used.

Advantageously, it is optionally provided that the test camera is designed such that it can detect the light spectrum of ultraviolet light and/or visible light and/or infrared light. The test camera can preferably detect the same light spectrum that can be emitted by the at least one light source used. This includes in particular visible light and ultraviolet light. Ultraviolet light can be emitted for example by a fluorescent or phosphorescent security feature of the marking, or the marking itself when a light-emitting imprint is used.

### BRIEF DESCRIPTION OF THE DRAWINGS

Further advantageous embodiments of the device and method for checking a marking are explained with reference to embodiments shown in the drawing, in which:

FIG. 1 is a schematic overview of the checking method comprising a layout checking step and a subsequent code checking step.

### DETAILED DESCRIPTION

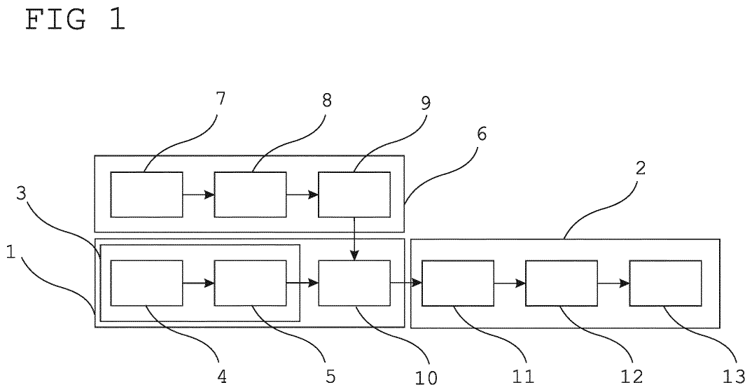

FIG. 1 is a schematic overview of the checking method for checking a marking of a product. The method comprises a layout checking step 1 and a code checking step 2 which can be carried out following the successful layout checking step 1. In the layout checking step 1, static data of the marking are checked for possible correspondence, while in the following code checking step 2 variable product information within the marking is checked.

In a first step of the layout checking step 1, the image acquisition step 3, the actual layout of the marking to be checked is generated. In this case, firstly an image of the marking 4 is recorded using a calibrated test camera. The edges of the image are extracted using a suitable digital filter, and stored as an edge model of the actual layout 5 in a data format suitable for edge models. The target layout is generated in that, in a reference database generation step 6, preferably using the same calibrated test camera or using a comparable calibrated test camera, an image of the desired marking 7 is recorded and converted, analogously to the actual layout, into an edge model 8. In the edge model of the target layout 8, the at least one region that contains at least one item of variable product information is marked as the product information region 9. The position thereof is stored depending on the position of the edge model 8. The edge model 8 of the marking, and the relative position of the at least one product information region 9, is assigned a code, for unique assignment, and all the data are stored in the reference information database. The generation of the target layout, or the reference database generation step 6, typically have to be carried out just once, at the start of carrying out the layout checking step 1, for a large number of markings of a corresponding number of products.

Subsequently, the edge model of the actual layout 5 is compared with the edge model of the target layout 8 for possible correspondence 10. In this case, the edge models 5, 8 are laid on top of one another and moved and rotated until a maximum correspondence is achieved. This correspondence is assigned a correspondence characteristic. In the case of a defined value of the correspondence characteristic, and thus a predetermined minimum correspondence of the actual and target layout 5, 8, being exceeded, the code checking step 2 subsequently follows the now successfully completed layout checking step 1. In the event of the minimum value of the correspondence characteristic not being met, the layout checking step 1 is considered to have failed.

In the code checking step 2 which follows the layout checking step 1, the actual layout generated in the layout checking step 1 is checked for encrypted variable product information present in the marking. For this purpose, the at least one product information region, the position of which relative to the marking was defined in the reference database generation step, is cut out 11 of the actual layout. The product information contained in the product information region is read out 12 and compared 13 with reference information from the product information database or a manual input.

### LIST OF REFERENCE SIGNS

1 layout checking step
2 code checking step
3 image acquisition step
4 image of the actual marking
5 edge model of the actual layout
6 reference database generation step
7 image of the target marking
8 edge model of the target layout
9 definition of at least one product information region
10 comparison of the actual layout with the target layout
11 cutting out of the product information region
12 reading out of the product information
13 matching of the product information with the reference information database

1.-15. (canceled)

16. A method for checking a marking of a product, comprising:
acquiring, in an image acquisition step (3), at least one image (4) of the marking arranged on a surface of the product by a calibrated test camera;
checking, in a layout checking step (1), using the at least one image (4), a quality of the marking applied to the surface with respect to static data including at least one of position and machine-readability;
acquiring, using the at least one image (4) recorded using the test camera, in a code checking step (2) variable product information (12) contained in the marking;
comparing the variable product information (12) with reference information from a reference information database (13); and
determining, by the comparing, a correspondence characteristic,
wherein the marking is successfully checked if the correspondence characteristic exceeds a predefinable success threshold.

17. The method according to claim 16,
wherein a language of the marking is identified in the code checking step (2) by a comparison of the variable product information (12) with language information from the reference information database (13).

18. The method according to claim 16,
wherein in the code checking step (2) the product information (12), encrypted in at least one one-dimensional or multi-dimensional and machine-readable code and/or security element, is acquired and is compared by a comparison of the variable product information with reference product information from the reference information database (13).

19. The method according to claim 16,
wherein, in the image acquisition step (3), UV light, and/or visible light, and/or infrared light is directed by a light source onto the marking and is reflected thereby, is acquired by the test camera, and processed in a data processing facility.

20. The method according to claim 16,
wherein, in the image acquisition step (3), the at least one image recorded by the test camera is stored in a storage device of the data processing facility.

21. The method according to claim 20,
wherein, in a reference database generation step (6), a target layout comprising a desired static data of the marking is generated,
wherein the target layout is stored in the reference information database,
wherein the static data of the target layout are compared with the static data of an actual layout, and
wherein a correspondence characteristic is determined by the comparison.

22. The method according to claim 21,
wherein, in the image recording step (3), the actual layout is generated from the static data from the at least one image,
wherein the actual layout (5) is stored in the storage device, and
wherein the static data of the actual layout are compared with the static data of the target layout,
wherein a correspondence characteristic is determined by the comparison.

23. The method according to claim 21,
wherein the target layout is a generated edge model (8) of the desired marking,
wherein the target layout is stored in the reference information database as an edge model (8).

24. The method according to claim 21,
wherein the actual layout is an edge model (5),
wherein the edge model (5) is generated from the at least one image recorded in the image recording step, and
wherein the actual layout is stored in the storage device as an edge model (5) for comparison with the target layout.

25. The method according to claim 16,
wherein based on the correspondence characteristic determined in the layout checking step (1), in an event of a value of the correspondence being exceeded, at least one product information region is cut out of the actual layout,
wherein in the code checking step, the variable product information of the at least one product information region is checked.

26. A device for checking a marking of a product,
wherein, in an image acquisition step (3), at least one image of the marking arranged on a surface of the product is acquired by a calibrated test camera, and
wherein, in a layout checking step (1), using the at least one image (4) a quality of the marking applied to the surface is checked with respect to static data such as position and machine-readability,
wherein the device comprises a digital data processing facility which is designed such that, using the at least one image (4) recorded using the test camera, in addition to the checking of the quality of the marking in the layout checking step (1), in a code checking step (2) variable product information (12) contained in the marking is acquired, and the variable product information is compared with reference information from a reference information database (13),
wherein by the comparison a correspondence characteristic is determined.

27. The device according to claim 26,
wherein the data processing facility comprises a storage device that is connected to the test camera, wherein, in the image recording step (3), images recorded by the test camera can be stored in the storage device.

28. The device according to claim 27,
wherein the data processing facility comprises a database, wherein the database is connected for signal transmission to the storage device, such that images (4) stored in the storage device can be matched with images (7) of the database.

29. The device according to claim 26,
wherein the test camera comprises at least one light source, by means of which the marking to be checked can be illuminated.

30. The device according to claim 26,
wherein the test camera is designed to detect ultraviolet light and/or visible light and/or infrared light.
